(19) United States
(12) Patent Application Publication
(10) Pub. No.: US 2009/0176535 A1
(43) Pub. Date: Jul. 9, 2009

(54) Communication Terminal Device and Storage Medium

(75) Inventors: Masaaki SONODA, Kunitachi-shi (JP); Haruhisa TAKAYANAGI, Hamura-shi (JP); Yuichi Kagota, Nakano-ku (JP); Yukou Nakajima, Fussa-shi (JP)

Correspondence Address: COHEN, PONTANI, LIEBERMAN & PAVANE LLP, 551 FIFTH AVENUE, SUITE 1210, NEW YORK, NY, 10176, US

(73) Assignee: Casio Hitachi Mobile Communications Co., Ltd., Tokyo (JP)

(21) Appl. No.: 12/351,202

(22) Filed: Jan. 9, 2009

(30) Foreign Application Priority Data
Jan. 9, 2008 (JP) 2008-001805

(51) Int. Cl. H04M 1/00; G06F 3/048

(52) U.S. Cl. 455/566; 715/771

(57) ABSTRACT

The controller, under a condition where in association with a plurality of pieces of its own communication identifying information (for example, two subscriber directory numbers), divided screen information when dividing and displaying a predefined screen (standby screen) of a display unit by the number of subscriber directory numbers, and communication-related information (arrival information) when performing voice call or mail arrival using the subscriber directory numbers are stored in a communication management table, associates each of the divided screens with each of the subscriber directory numbers, and also displays the arrival information for each of the subscriber directory numbers on a corresponding divided screen.

### BACKGROUND OF THE INVENTION

1. Field of the Invention

The present invention relates to a communication terminal device and a storage medium.

2. Description of the Related Art

There is a communication terminal device which can use a plurality of phone numbers (referred to as subscriber directory numbers, hereinafter) as a plurality of pieces of its own communication identifying information. For example, Unexamined Japanese Patent Application KOKAI Publication No. 2003-189361 describes a mobile communication terminal which allows simultaneous standby states for a plurality of subscriber directory numbers by registering a plurality of subscriber directory numbers in the nearest base station. Unexamined Japanese Patent Application KOKAI Publication No. 2006-121335 also describes a technique for such a communication terminal, which outputs different sounds or images for each of the subscriber directory numbers when a call arrives, in order to allow a user to identify at which subscriber directory number the call arrives. In addition, Unexamined Japanese Patent Application KOKAI Publication No. 2006-121336 describes a technique in which the above technique for receiving electronic mails is used.

### SUMMARY OF THE INVENTION

It is an object of the invention to allow a user, when performing communication, to easily recognize which of a plurality of pieces of its own communication identifying information is used to perform the communication.

A communication terminal device of the present invention, which is a communication terminal device capable of communicating using any of a plurality of pieces of its own communication identifying information, comprises an information storage unit which stores, when communication is performed using the communication identifying information, communication-related information indicating that the communication has been performed, in association with the communication identifying information; a dividing unit which divides a display screen by the number of the plurality of pieces of communication identifying information; and a display control unit which associates each of the divided screens divided by the dividing unit with each of the pieces of communication identifying information, and which displays the communication-related information for each of the pieces of communication identifying information on a corresponding divided screen.

Furthermore, a storage medium that stores a program is provided to the computer, which realizes major functions of the above-mentioned invention.

According to the present invention, it is easy to recognize which one of the plurality of pieces of its own communication identifying information has been used to perform the communication.

### BRIEF DESCRIPTION OF THE DRAWINGS

These objects and other objects and advantages of the present invention will become more apparent upon reading of the following detailed description and the accompanying drawings in which:

FIG. 1 is a block diagram illustrating basic components of a mobile phone device applied as a communication terminal device;

FIG. 2 is an explanatory diagram of a communication management table;

FIGS. 3A and 3B illustrate, under a condition where a standby screen is divided into two, i.e., the upper and lower halves according to the number of subscriber directory numbers, an exemplary display of its communication-related information for each of the subscriber directory numbers on a corresponding divided screen;

FIG. 4 is a flow chart describing in detail the characteristic part of this first embodiment among the overall operation of the mobile phone device which is started at power-on;

FIG. 5 is a flow chart describing the operation continuing from FIG. 4;

FIG. 6 is a flow chart describing the standby screen display processing (step A1 of FIG. 4) in detail;

FIG. 7 is an explanatory diagram of a communication management table in a second embodiment;

FIGS. 8A and 8B illustrate an exemplary display of the communication-related information for each of the subscriber directory numbers in a divided manner on the upper and lower halves of the standby screen;

FIG. 9 is a flow chart replacing the flow chart of FIG. 5 and describing the operation continuing from FIG. 4 in the second embodiment; and

FIG. 10 is a flow chart replacing the flow chart of FIG. 6 and describing in detail the standby screen display processing (step A1 of FIG. 4) in the second embodiment.

### DETAILED DESCRIPTION OF THE PREFERRED EMBODIMENTS

### First Embodiment

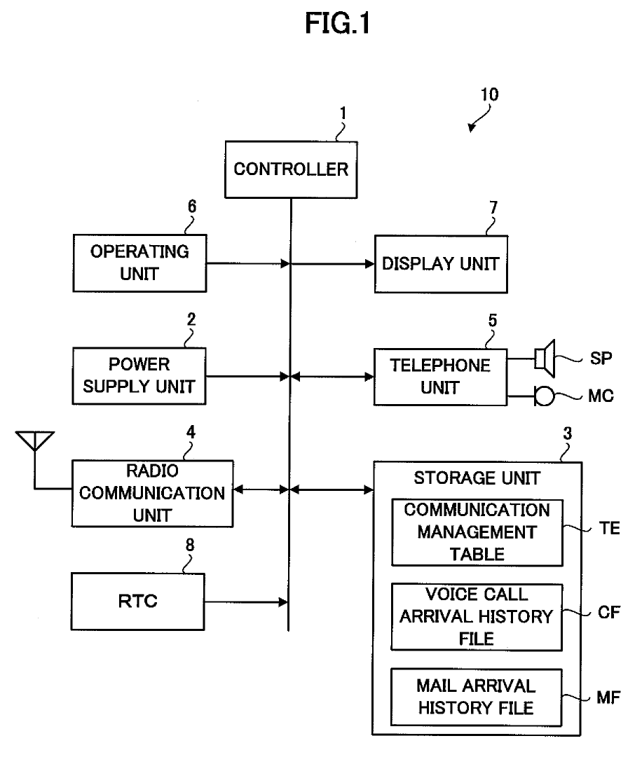

A first embodiment of the present invention will be described below, referring to FIGS. 1 to 6.

The embodiment illustrates a case applied to a mobile phone device 10 as a communication terminal. FIG. 1 is a block diagram illustrating basic components of a mobile phone device 10.

The mobile phone device 10 comprises the functions of voice call, electronic mail (for example, transmitting and receiving short messages), Internet connection (Web access), dual phone number management, or the like. When connected to a mobile communication network (not shown) through the nearest base station or an exchange, the mobile phone device 10 is enabled to communicate with other mobile phone devices via the mobile communication network. In addition, when connected to a mail server (not shown) via the mobile communication network, the mobile phone device 10 is enabled to transmit and receive electronic mails (for example, short messages) between the device and the mail server. Dual phone number management function allows simultaneous standby states for respective phone numbers (two subscriber directory numbers) which are memory-managed as a plurality of pieces of its own communication identifying information. In addition, the dual phone number management function transmits and receives telephone calls by selectively switching to either one of the subscriber directory numbers.

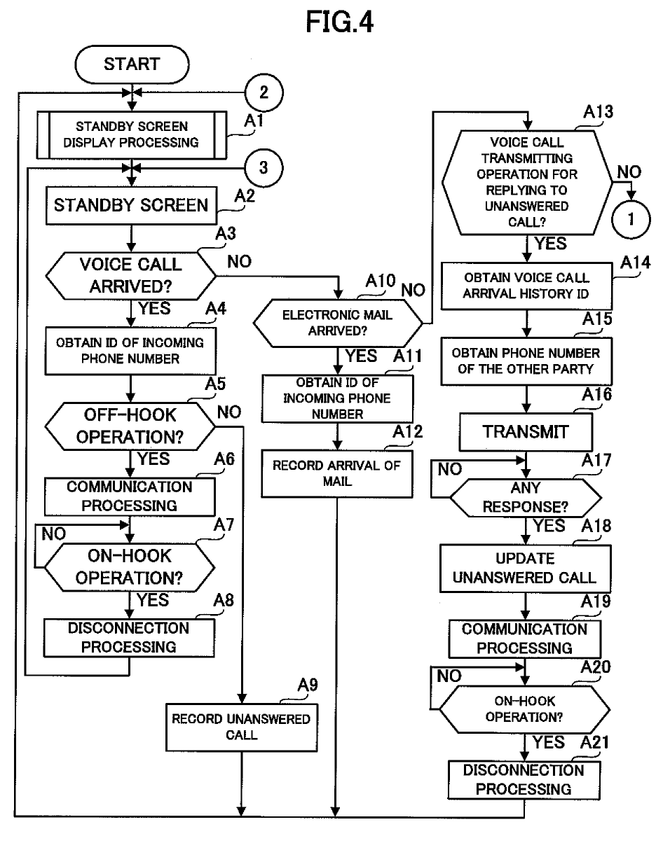

As shown in FIG. 1, the mobile phone device 10 comprises a controller 1, a power supply unit 2, a storage unit 3, a radio communication unit 4, a telephone unit 5, an operating unit 6, a display unit 7, and an RTC (real-time clock module) 8. The controller 1 is operated by power supply from the power supply unit 2 comprising a secondary battery. In addition, the controller 1 controls the overall operation of the mobile phone device 10 according to a variety of programs in the storage unit 3. The controller 1 comprises a CPU (central processing unit), a memory, or the like. The storage unit 3 is an internal memory of the mobile phone 10 and has a program area and a data area. In the program area, programs are stored for implementing the present embodiment according to the operation procedures shown in FIGS. 4 to 6 which will be described below. Additionally, in the data area of the storage unit 3, a communication management table TE, a voice call arrival history file CF, and a mail arrival history file MF are stored, which will be described below.

The radio communication unit 4 comprises a radio unit, a baseband unit, a multiplexing and demultiplexing unit, or the like. The radio communication unit 4 transmits and receives data to and from the nearest base station when the functions of, for example, voice call, electronic mail and Internet connection are active. Additionally, when the voice call function is active, the radio communication unit 4 takes in a signal from the receiving side of the baseband unit, demodulates it into a received baseband signal, and inputs the received baseband signal to the telephone unit 5. Furthermore, the radio communication unit 4 receives an input audio data from the telephone unit 5, and after having encoded the received input audio data into a transmission baseband signal, inputs the signal to the transmitting side of the baseband unit, causing the signal to be output for transmission from the antenna.

The telephone unit 5 causes the received baseband signal which has been input from the radio communication unit 4 to be output as sound from a speaker SP used for calls under control of the controller 1. In addition, the telephone unit 5 inputs the audio data input from a microphone MC used for calls to the radio communication unit 4 under control of the controller 1.

The operating unit 6, which to handle dial input, character input and command input, and transmits an operating signal according to the user-operation to the controller 1. The controller 1 executes a processing according to the operating signal transmitted from the operating unit 6.

The display unit 7, comprising a high definition liquid crystal or organic EL (Electro-Luminescence), displays standby images, character information, or the like.

The RTC 8, composing the clock unit, measures the current time of day. The controller 1 obtains the current time and date from the RTC 8.

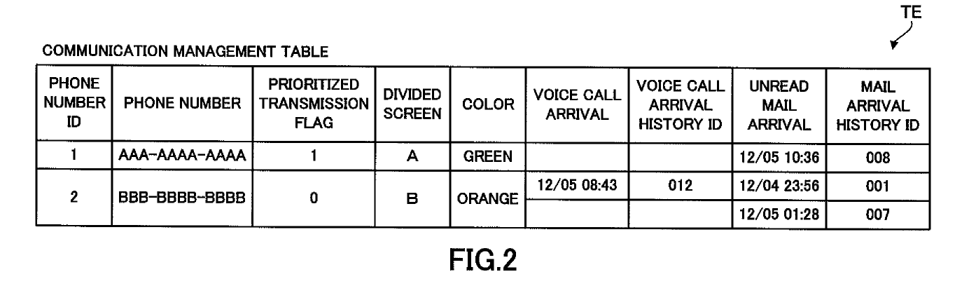

FIG. 2 is an explanatory diagram of a communication management table TE.

The communication management table TE associates a plurality of its own subscriber directory numbers constituting the dual phone number management function with information about the divided screen when the screen is divided by the number of subscriber directory numbers, communication-related information (arrival information) indicating the content of incoming voice calls or mails for the subscriber directory numbers, or the like.

The communication management table TE comprises the fields of “phone number ID”, “phone number”, “prioritized transmission flag”, “divided screen”, “color”, “voice call arrival”, “voice call arrival history ID”, “unread mail arrival”, and “mail arrival history ID”.

The “phone number ID” is a field which stores an ID which specifies a plurality of its own subscriber directory numbers, and the “phone number” is a field which stores the subscriber directory number. Here, an example of two subscriber directory numbers is shown.

The “prioritized transmission flag” is a field which stores a flag for specifying a transmitting phone number currently used on a priority basis out of the two subscriber directory numbers, where the value of “1” indicates that it is a prioritized transmitting phone number. Here, the example of FIG. 2 shows that the “phone number” for “phone number ID=1” is the prioritized transmitting phone number.

The “divided screen” is a field which stores information specifying respective divided screens when standby screen is divided by the number of its own subscriber directory numbers.

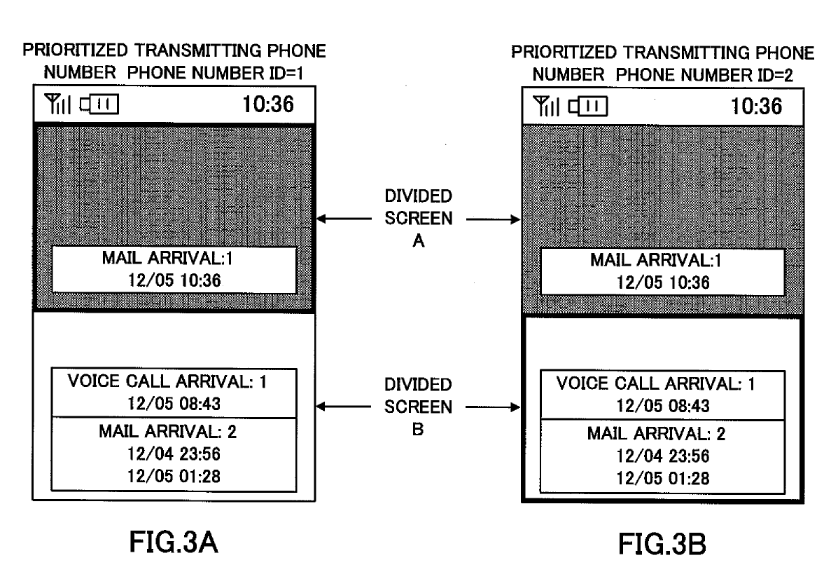

FIGS. 3A and 3B illustrate an exemplary display of communication-related information (arrival information) under a condition where the standby screen is divided in two, the upper and lower, halves according to the number of subscriber directory numbers, the communication-related information being displayed for each of the subscriber directory numbers on the corresponding divided screen. In the example of FIG. 2, the upper divided screen A is associated with the “phone number” for “phone number ID=”, and the lower divided screen B is associated with the “phone number” for “phone number ID=2”. In this manner, each of the divided screens can be associated with each of the “phone numbers” on a one-to-one basis.

The “color” is a field which stores background color of the corresponding divided screen. FIG. 2 shows an example where the background color of the upper divided screen A is green and the lower divided screen B is orange.

The “voice call arrival” and the “unread mail arrival” are fields for storing communication-related information (arrival information, in this example) indicating that a communication has been performed using a corresponding “phone number”. The “voice call arrival” is a field which stores the arrival time and date of voice calls, and “unread mail arrival” is a field which stores the arrival time and date of unbrowsed or unread electronic mails (for example, short message).

The “voice call arrival history ID” stores the link destination of the voice call arrival history file CF.

In addition, the “mail arrival history ID” is a field which stores the link destination of the mail arrival history file MF. Here, the voice call arrival history file CF is a file for storing, as well as the voice call arrival history ID, the arrival time and date and the phone number of the opposite party. In addition, the mail arrival history file MF is a file for storing, as well as the mail arrival history ID, the arrival time and date and the phone number of the opposite party.

The content of the “voice call arrival” and “unread mail arrival” is displayed in respective halves of the divided standby screen as shown in FIGS. 3A and 3B. That is, in the illustrated example, the content of “voice call arrival” and “unread mail arrival” corresponding to “phone number ID=1” is displayed on the upper half A of the divided standby screen. In addition, the content of “voice call arrival” and “unread mail arrival” corresponding to “phone number ID=2” is displayed on the lower half B of the divided standby screen.

When either half of the divided screen is selected out of the halves of the divided screen by the user's operation, the “prioritized transmission flag” is updated according to the selected half of the divided screen, whereby switching to the transmitting phone number (prioritized transmitting phone number) to be used with priority. In other words, the value of “prioritized transmission flag” corresponding to the selected half of the divided screen is set to “1”, whereas the “prioritized transmission flag” corresponding to the other half of the divided screen is set to “0”, thereby switching the prioritized transmitting phone number.

Next, the operation of the mobile phone device 10 in the first embodiment will be described referring to the flow chart shown in FIGS. 4 to 6. Each of the functions described by the flow charts is stored in a program area of the storage unit 3 in the form of a readable program code, and the operation is executed sequentially according to the program code. Here, it may be arranged such that operations are sequentially executed according to the program code which has been transmitted via a transmission medium. This is similar with other embodiments which will be described below.

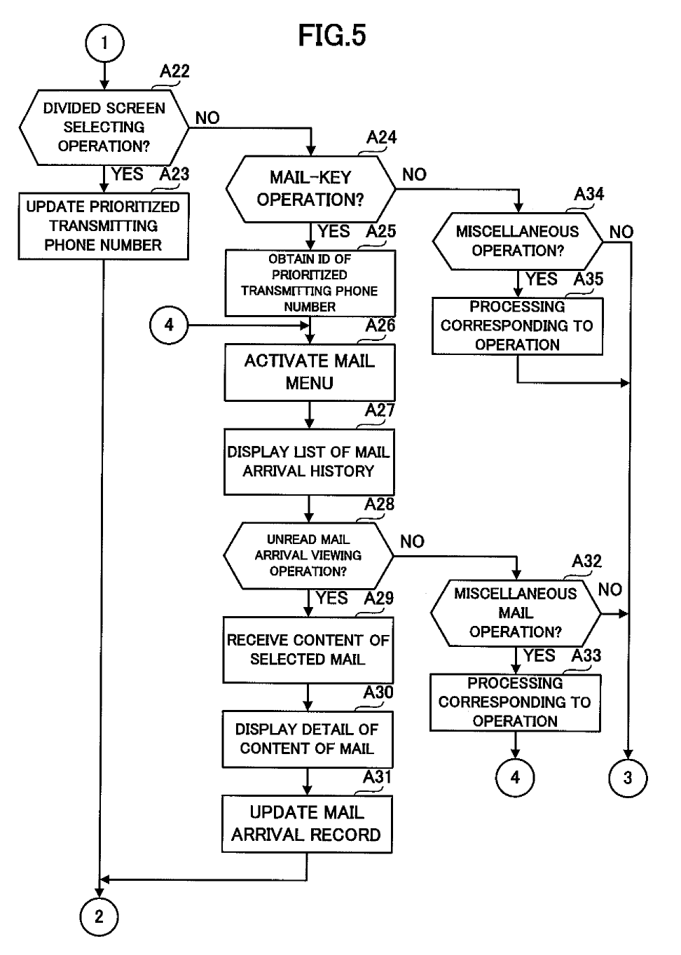

FIGS. 4 and 5 are flow charts describing in detail the characteristic part of the first embodiment among the overall operation of the mobile phone device 10 which is started at power-on.

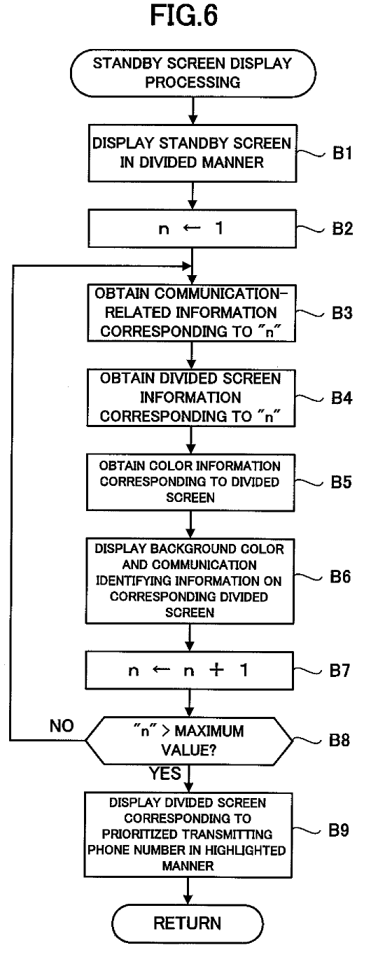

When the mobile phone device 10 is powered on, the controller 1 first proceeds to execute a standby screen display processing (step A1). FIG. 6 is a flow chart describing the standby screen display processing in detail.

In the standby screen display processing, the controller 1 first divides the standby screen by the number of its own subscriber directory numbers (step B1). In the example shown in FIG. 2, the standby screen is divided in two, the upper and lower, halves. The controller 1 then sets “1” as the initial value of a pointer n for sequentially specifying the subscriber directory numbers, i.e., a pointer n which sequentially specifies the “phone numbers” within the communication management table TE (step B2). Based on the value of the pointer n, the controller 1 accesses a “phone number ID” of the communication management table TE, and specifies a “phone number” for which the value of “phone number ID” is the value of the pointer n, i.e., the “phone number” for which “phone number ID=pointer n” holds, and obtains information of the fields “voice call arrival” and “unread mail arrival” as the communication-related information (arrival information) associated with this “phone number” (step B3). In the example shown in FIG. 2, since the value of the pointer n is “1”, “10:36, December 5th” is read out from the “unread mail arrival” as the communication-related information (arrival information) of the “phone number” corresponding to “phone number ID=1”.

The controller 1 then obtains information of the field “divided screen” associated with the “phone number” for which “phone number ID=pointer n” holds, as the target display screen, (step B4), as well as information of the field “color” corresponding to this “divided screen” (step B5). The controller 1 then colors the background of the divided screen in the color indicated by the field “color”, and displays the communication-related information (arrival information) obtained in step B3 on the divided screen (step B6). In the example shown in FIG. 2, the “10:36, December 5th” which has been read out from the “unread mail arrival” is displayed on the divided screen A as the communication-related information (arrival information), as shown in FIG. 3A, under a condition where the divided screen A is the target display with its entire background colored in green. Here, the arrival information displayed on the divided screen comprises its type of communication and arrival time and date, where the “voice call arrival” and “mail arrival” shown in FIG. 3A are of this type of communication. In this case, “voice call arrival” indicates arrival of a voice call, whereas “mail arrival” indicates arrival of an electronic mail.

The numerical value added to the “:” following the type of communication is the number of arrivals, which is counted for each type of communication and displayed together with the type of communication by the controller 1. In addition, the numerical value following the “type of communication: number of arrivals” indicates the arrival time and date. In this case, it is arranged such that arrival information of voice calls and arrival information of electronic mails are displayed within respective divided screens in a separated manner.

Next, the controller 1 adds “1” to the pointer n to update its value (step B7), and determines whether or not the value of the pointer n exceeded its maximum value (step 138). In the example of FIG. 2, “2” is set as the maximum value. Here, since the value of the pointer n is updated to “2”, which does not exceed the maximum value “2” (step B8; NO), the process flow returns to step B3 and the controller 1 repeats the above-mentioned operation (step B3 to B8).

In the processing of steps B3 to B8 after the value of the pointer n is updated to “2”, “08:43, December 5th” is read out from the “voice call arrival” as the arrival information of the “phone number” corresponding to “phone number ID=2”, and “23:56, December 4th” and “01:28, December 5th” are read out from the “unread mail arrival”. Then, the divided screen B becomes the target display screen and, with its entire background colored in orange, “08:43, December 5th” which has been read out from the “voice call arrival”, and “23:56, December 4th” and “01:28, December 5th” which have been read out from the “unread mail arrival” are displayed on the divided screen B as the arrival information, as shown in FIG. 3B.

Subsequently, if the value of the pointer n exceeds its maximum value (step B8: YES), the controller 1 specifies the prioritized transmitting phone number based on the “prioritized transmission flag” within the communication management table TE, and displays the entire divided screen associated with the phone number in a highlighted manner, i.e., displays by heavy lines the outer border of the divided screen (step B9). FIG. 3A shows a case where a “phone number” corresponding to “phone number ID=1” is selected as the prioritized transmitting phone number, and the divided screen A is displayed in a highlighted manner. FIG. 3B shows a case where a “phone number” corresponding to “phone number ID=2” is selected as the prioritized transmitting phone number, and the divided screen B is displayed in a highlighted manner. Subsequently, the controller 1 terminates the standby screen display processing, and exits the flow chart shown in FIG. 6.

If the standby screen display processing (step A1 of FIG. 4) is completed in this manner, content of the “voice call arrival” and “unread mail arrival” corresponding to “phone number ID=1” is displayed on the divided screen A of the standby screen, whereas content of the “voice call arrival” and “unread mail arrival” corresponding to “phone number ID=2” is displayed on the divided screen B. Then, proceeding to step A2 of FIG. 4, a standby state (step A2) is entered where miscellaneous information (remaining battery level, reception sensitivity, time of day, etc.) is displayed on the standby screen. In the standby state, the controller 1 determines, whether or not a voice call has arrived (step A3), whether or not an electronic mail has arrived (step A10), and whether or not a variety of user-operation has been performed (step A13, steps A22, A24 and A34 of FIG. 5).

In the standby state where the mobile phone is waiting with the “phone number” corresponding to “phone number ID=1”, or the “phone number” corresponding to “phone number ID=2”, the controller 1, upon detecting the arrival of a voice call with either phone number being the destination (step A3; YES), obtains the corresponding “phone number ID” by searching the communication management table TE based on the phone number which is the destination of the incoming call (step A4). The controller 1 then determines whether or not a user operation (an off-hook operation) has been performed (step A5) in response to arrival of calls or mails.

If an off-hook operation is not performed and the line is disconnected by the opposite party (step A5; NO), the controller 1 returns to the standby screen display processing (step A1) after having recorded the current time and date, as time and date of unanswered call, in the “voice call arrival” corresponding to the “phone number ID” (step A9). It thus becomes possible to display information including the unanswered call record on the standby screen. If, on the other hand, an off-hook operation is performed while a call is incoming (step A5; YES), the controller 1 executes a communication processing which enables communication (step A6). Then, in response to the on-hook operation during the call processing (step A7; YES), the controller 1 returns to the standby state (step A2) after having disconnected the line (step A8).

If an arrival of an incoming electronic mail (short message) is detected in the standby state (step A10; YES), the controller 1 searches the communication management table TE based on the phone number which is the destination of the mail arrival and, after having retrieved the corresponding “phone number ID” (step A11), records the current time and date, as time and date of mail arrival, in the “unread mail arrival” corresponding to the “phone number ID” (step A12), then returns to the standby screen display processing (step A1). It thus becomes possible to display information including the mail arrivals record on the standby screen.

Additionally, if a voice call transmitting operation for calling the opposite party of the unanswered call is performed (step A13; YES), under a condition where arrival information corresponding to “phone number ID=1” is displayed on the divided screen A of the standby screen and arrival information corresponding to “phone number ID=2” is displayed on the divided screen B, the controller 1 proceeds to the transmitting processing to the opposite party (steps A14 to A21). Here, for example, “arrival 1: 12/05 08:43” is selected from the “voice call arrival” displayed on the divided screen B, and a transmitting operation to the opposite party is executed.

In a condition where the divided screen B is displayed in a highlighted manner as shown in FIG. 3B, that is, the “phone number” for “phone number ID=2” is selected as the prioritized transmitting phone number, an operation is allowed to simply select “arrival 1: 12/05 08:43” within the divided screen B. However, under a condition where the divided screen A is displayed in a highlighted manner as shown in FIG. 3A, that is, the “phone number” for “phone number ID=1” is selected as the prioritized transmitting phone number, it is necessary to first switch the highlighted display from the divided screen A to the divided screen B in order to select the “phone number” for “phone number ID=2” as the prioritized transmitting phone number.

Here, if an operation of selecting a divided screen in order to switch from the divided screen A to the divided screen B is detected (step A22 of FIG. 5; YES), the controller 1 updates the “prioritized transmission flag” corresponding to the divided screen from “0” to “1” and updates the “prioritized transmission flag” corresponding to the other divided screen from “1” to “0” (step A23) in order to set the “phone number” corresponding to the divided screen newly selected this time as the prioritized transmitting phone number. In this manner, the prioritized transmitting phone number is switched from the “phone number” corresponding to the divided screen A to the “phone number” corresponding to the divided screen B, for example.

Then, if an operation of selecting “arrival 1: 12/05 08:43” from the unanswered call record displayed on the divided screen is performed under a condition where the divided screen presenting “voice call arrival”, i.e., the unanswered call record is displayed in a highlighted manner, in other words, for example, under a condition where the divided screen B is displayed in a highlighted manner and the “phone number” for “phone number ID=2” is selected as the prioritized transmitting phone number as shown in FIG. 3B, the controller 1 retrieves the “voice call arrival history ID” associated with the unanswered call record (step A14 of FIG. 4).

The controller 1 then accesses the voice call arrival history file CF based on the “voice call arrival history ID”, and retrieves the “opposite party's phone number” from the call arrival history (step A15). The controller 1 then calls the opposite party's phone number (step A16), originating the call from the prioritized transmitting phone number. Subsequently, upon receiving a response from the opposite party (step A17; YES), the controller 1 executes a communication processing which enables communication (step A19), after having updated the content of “voice call arrival” by deleting the “arrival 1: 12/05 08:43” which is an unanswered call record (step A18). Here, if an on-hook operation is performed (step A20; YES), the controller 1 returns to the standby screen display processing (step A1), after having executed a line disconnection processing (step A21).

If, on the other hand, a mail key operation is performed (step A24 of FIG. 5; YES), the controller 1 activates the mail menu (step A26) and displays a list of the content of the mail arrival history file MF (step A27), after having accessed the communication management table TE and retrieved the “phone number ID” corresponding to the “prioritized transmission flag” being “1” as the ID of the prioritized transmitting phone number (step A25). If an operation of arbitrarily selecting and instructing to read the unread mail from the list is performed (step A28; YES), the controller 1 receives the content of the selected mail from the mail server which is connected via a mobile communication network (step A29), and displays the content of the mail in detail (step A30). Subsequently, the controller 1 accesses the communication management table TE based on the above-mentioned “phone number ID”, and returns to the standby screen display processing (step A1 of FIG. 4), after having updated the “unread mail arrival” by deleting content of the “unread mail arrival” (step A31).

Here, if an operation other than reading an unread mail (miscellaneous mail operation) is performed (step A32; YES) the controller 1 returns to step A26 mentioned above, after having executed mail storing or mail deleting, for example, according to the miscellaneous mail operations (step A33). Additionally, if a miscellaneous mail operation is not executed (step A32; NO), the controller 1 returns to step A2 of FIG. 4. Additionally, if an operation other than a mail key operation is performed (step A34; YES), the controller 1 returns to step A2 of FIG. 4, after having executed a processing corresponding to the operation (step A35).

As thus described, in the first embodiment under a condition where divided screen information of the display screen (standby screen) when the screen is divided by the number of pieces of the communication identifying information, and communication-related information when voice call communication or mail arrival is executed using the communication identifying information are stored in the communication management table TE in association with a plurality of pieces of its own communication identifying information, the controller 1 associates each of the divided screens with each of the pieces of communication identifying information, and also displays the communication-related information on the corresponding divided screen for each of the pieces of communication identifying information. In this manner, even if the plurality of pieces of communication-related information is displayed on the same display screen when performing communication using a plurality of pieces of communication identifying information, it is easy to recognize which communication identifying information the present information corresponds to, whereby misconception or false recognition of information, or increase of complexity of operation can be prevented. In this case, since the communication-related information is displayed on the standby screen, it becomes easier to confirm the information.

Since communication is enabled, when an arbitrary divided screen is selected from respective divided screens using communication identifying information corresponding to the selected divided screen, the communication identifying information can be switched by simply selecting the divided screen, whereby switching can be easily performed.

Because the background color of each divided screen is differentiated, the user can easily recognize, even if a different piece of communication-related information is displayed on the same screen in a coexisting manner, which communication identifying information the displayed information is related to, owing to the background color.

Since the communication-related information stored in association with the communication identifying information is a piece of arrival information associated with a voice call, the user can easily recognize, when receiving an incoming voice call, which communication identifying information the call is destined to.

Since the communication-related information stored in association with the communication identifying information is a piece of arrival information associated with an electronic mail, the user can easily recognize, when receiving an incoming electronic mail, which communication identifying information the mail is destined to.

Since the number of times of the communication performed (number of arrivals) using the communication identifying information is also displayed when presenting the communication-related information stored in association with the communication identifying information, the user can also know the number of arrivals.

Since the communication time and date (arrival time and date) is also displayed when presenting the communication-related information (arrival information) stored in association with the communication identifying information, the user can also know the arrival time and date.

Since the type of communication is displayed when presenting the communication-related information (arrival information) stored in association with the communication identifying information, the user can know whether it is a voice call or an electronic mail. In this case, the user can easily distinguish them, because arrival information associated with a voice call and arrival information associated with an electronic mail are displayed on respective divided screens in a separated manner.

In the first embodiment, although respective divided screens are distinguished by their background colors, the divided screens may be distinguished by, for example, symbols or marks displayed on the divided screens. Similarly, although the external frame of the divided screen associated with the current prioritized transmitting phone number is displayed in a highlighted manner (heavy line display), the prioritized transmitting phone number may be explicitly indicated by, for example, symbol display or mark display within the divided screen. Additionally, although green and orange are used as the background colors, any color will do if it is distinguishable, and the user may be allowed to set these colors. Furthermore, although the number of phone numbers managed in the memory as the plurality of pieces of its own communication identifying information was assumed to be two, there may be more than two phone numbers. In this case, the display screen may be divided by that number. Additionally, in the first embodiment, although the display screen is divided into upper and lower halves, it may be divided into right and left halves, or divided along the circumferential direction. Any manner of division is applicable in dividing the screen as long as each divided screen is distinguishable.

### Second Embodiment

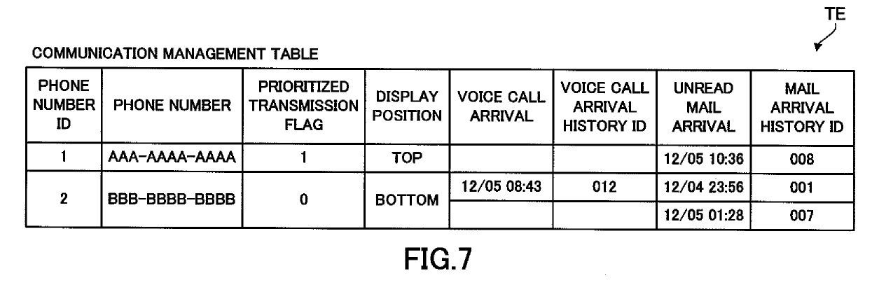

A second embodiment of the present invention will be described below, referring to FIGS. 7 to 10.

In the first embodiment mentioned above, arrival information is displayed, under a condition where the standby screen is divided by the number of its own subscriber directory numbers, on the corresponding divided screen for each of the subscriber directory numbers, with each of the divided screens being associated with each of the subscriber directory numbers. In the second embodiment, the arrival information is displayed at a display position assigned to each of the subscriber directory numbers on the standby screen.

Here, elements which are identical in terms of functions or name in both embodiments are illustrated with identical reference numbers, omitting their description. In the following, description will be provided mainly for characteristic parts of the second embodiment.

FIG. 7 illustrates a communication management table TE in the second embodiment.

The communication management table TE in the second embodiment comprises the fields of “phone number ID”, “phone number”, “prioritized transmission flag”, “voice call arrival”, “voice call arrival history ID”, “unread mail arrival”, and “mail arrival history ID” and, additionally, “display position”. The “display position” indicates the display position assigned to each of the subscriber directory numbers within the standby screen. In the example of FIG. 7, “top” is memorized as the “display position” assigned to the “phone number” corresponding to “phone number ID=1”, whereas “bottom” is memorized as the “display position” assigned to the “phone number” corresponding to “phone number ID=2”. In this case, when the standby screen is divided by the number (two) of its own subscriber directory numbers into the upper and lower halves (bisection), “top” indicates the display position in the upper half, whereas “bottom” indicates the display position in the lower half.

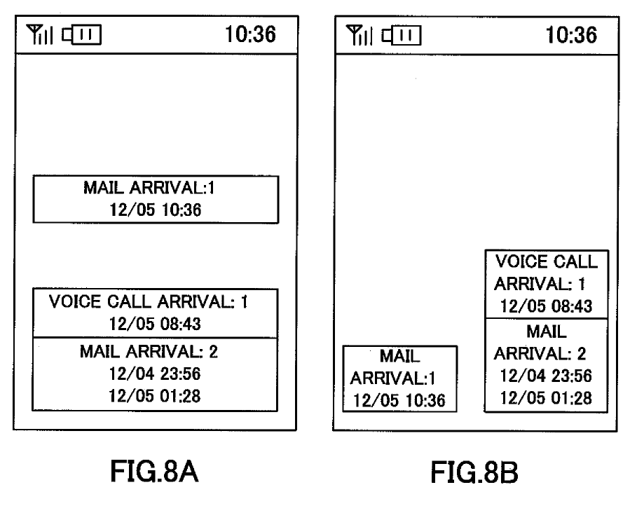

Since the other fields are similar with those of the first embodiment, their description is omitted. The content of “voice call arrival” and “unread mail arrival” are displayed, as shown in FIG. 8A, on the “display position” on the corresponding standby screen. That is, in the example of FIG. 7, content of “voice call arrival” and “unread mail arrival” corresponding to “phone number ID=1” are displayed at the display position of the upper half of the standby screen, whereas the content of “voice call arrival” and “unread mail arrival” corresponding to “phone number ID=2” are displayed on the display position in the lower half.

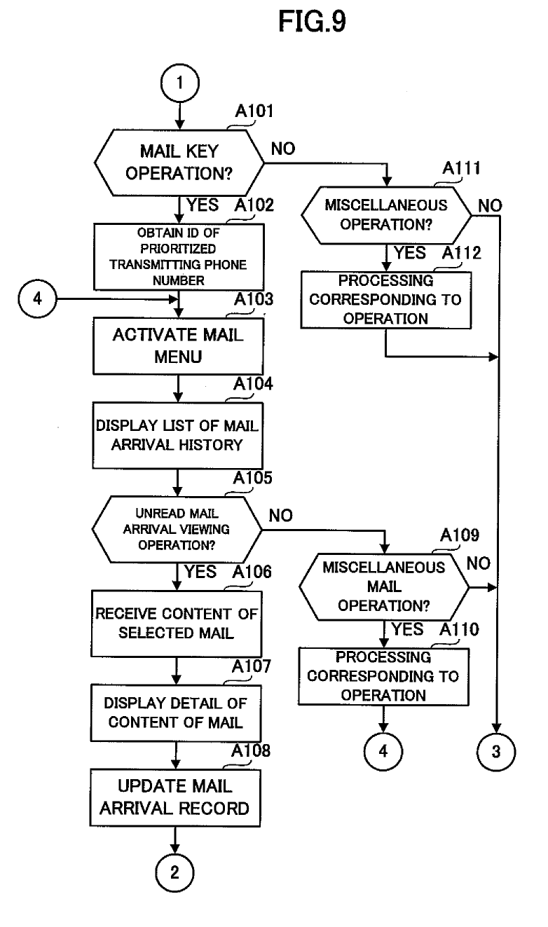

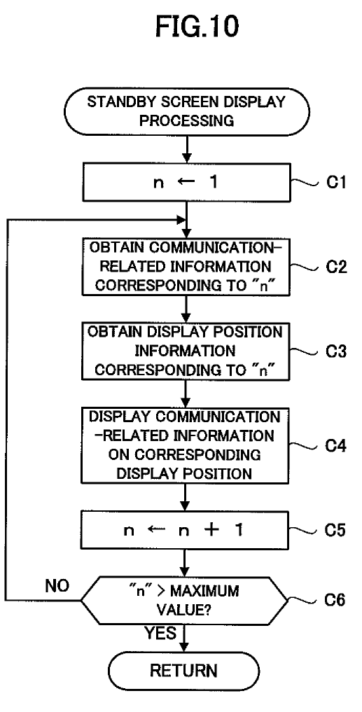

FIG. 9 is a flow chart continuing from FIG. 4 and replacing FIG. 5, and FIG. 10 is a flow chart replacing FIG. 6. In other words, FIGS. 4 and 9 in the second embodiment are flow charts describing in detail the characteristic part of the second embodiment among the overall operation of the mobile phone device 10 which is started at power-on. In addition, FIG. 10 is a flow chart describing in detail the standby screen display processing (step A1 of FIG. 4) of the second embodiment.

When powered on, the controller 1 first proceeds to execute the standby screen display processing (step A1 of FIG. 4).

In the standby screen display processing, the controller 1 first sets “1” as the initial value of the pointer n for sequentially specifying a plurality of its own subscriber directory numbers (step C1). Based on the value of the pointer n, the controller 1 accesses a “phone number ID” of the communication management table TE, and retrieves information of the fields of “voice call arrival” and “unread mail arrival” as the communication-related information (arrival information) associated with the “phone number” for which the value of “phone number ID” is the value of the pointer n, i.e., the “phone number” for which “phone number ID=pointer n” holds (step C2).

The controller 1 then retrieves information of the “display position” associated with the “phone number” for “phone number ID=pointer n” (step C3). The controller 1 displays the retrieved communication-related information (arrival information) at the corresponding “display position” within the standby screen (step C4). Here, since the value of the pointer n is “1”, “10:36, December 5th” is read out from the “unread mail arrival” as the arrival information of the “phone number” corresponding to “phone number ID=1”, and displayed on the upper half display position within the standby screen as shown in FIG. 8A.

Then, after having added “1” to the pointer n and updated the value (step C5), the controller 1 determines whether or not the value of the pointer n has exceeded the maximum value (“2”) (step C6). Since this is a case where the value of the pointer n is updated to “2” and not larger than the maximum value “2”, the controller 1 returns to step C2 and repeats the above-mentioned operation (steps C2 to C6). In this manner, “08:43, December 5th” is read out from the “voice call arrival”, and “23:56, December 4th” and “01:28, December 5th” are read out from the “unread mail arrival” as the arrival information of the “phone number” corresponding to “phone number ID=2”, and are displayed as shown in FIG. 8A at the display position of the lower half within the standby screen. Then, if the value of the pointer n exceeds the maximum value (step C6; YES), the controller 1 terminates the standby screen display processing and exits from the flow of FIG. 10.

When the standby screen display processing (step A1 of FIG. 4) is completed in this manner, content of the “voice call arrival” and “unread mail arrival” corresponding to “phone number ID=1” is displayed at the display position in the upper half of the standby screen, whereas content of the “voice call arrival” and the “unread mail arrival” corresponding to “phone number ID=2” is displayed at the display position of the lower half. Then the controller 1 proceeds to step A2 of FIG. 4, displays miscellaneous information (remaining battery level, reception sensitivity, time of day, etc.) on the standby screen, and enters the standby state (step A2).

Subsequently, as with the first embodiment a processing in response to a voice call arrival (steps A3 to A9), a processing in response to an electronic mail arrival (steps A10 to A12), and a processing in response to a voice call transmitting operation for replying to the unanswered call (steps A13 to A21) can be executed. In addition, although a processing in response to a mail key operation (steps A101 to A110 of FIG. 9) and a processing in response to miscellaneous operations (steps A111 and A112 of FIG. 9) can be executed similarly as the first embodiment the processing in response to the divided screen selection operation shown in FIG. 5 (steps A22 and A23) is not executed in the second embodiment because it is a processing specific to the first embodiment (FIG. 9).

Since, in the second embodiment, it is arranged such that the communication-related information (arrival information) is displayed at a position within the standby screen assigned, in the communication management table TE, to each of the subscriber directory numbers, corresponding to a plurality of pieces of communication identifying information (for example, two of its own subscriber directory numbers) as above, the user can easily recognize, even if different communication-related information is displayed on the same screen when the user performs communication using a plurality of pieces of communication identifying information, which communication identifying information the present information corresponds to, whereby misconception or false recognition of information, or increase of complexity of operation can be prevented. In this case, since the communication-related information is displayed on the standby screen, it becomes easier to confirm the information.

Additionally, the second embodiment also provides a similar effect as the first embodiment. That is, when arrival of a voice call is received, or arrival of an electronic mail is received, the user can easily recognize which communication identifying information is destined to. In addition, the user can know whether it is a voice call or an electronic mail, as well as the number of arrivals, and arrival time and date.

In the second embodiment, although the standby screen is divided by the number (two) of its own subscriber directory numbers into upper and lower halves (bisection) as shown in FIG. 8A, and arrival information corresponding to “phone number ID=1” is displayed at a display position in the upper half whereas arrival information corresponding to “phone number ID=2” is displayed at a display position in the lower half, it may be arranged such that the standby screen is divided by the number (two) of its own subscriber directory numbers into the right and left halves as shown in FIG. 8B, and information corresponding to “phone number ID=1” is displayed at a display position in the left half whereas arrival information corresponding to “phone number ID=2” is displayed at a display position in the right half.

Additionally, in the second embodiment, without limiting the display position on the standby screen to upper and lower, or right and left positions, it may be arranged such that the arrival information corresponding to “phone number ID=1” is displayed on the odd number line of the standby screen whereas arrival information corresponding to “phone number ID=2” is displayed on the even number line of the standby screen. In other words, the arrival information may be at a display position corresponding to the subscriber directory number.

Additionally, in respective embodiments mentioned above, although the subscriber directory number has been described as a plurality of pieces of its own communication identifying information, mail addresses or user accounts may be used without being limited to phone numbers. In addition, electronic mails received via the Internet may be suitable as mails, without being limited to short messages.

Additionally, in respective embodiments mentioned above, although arrival of voice calls or arrival of electronic mails on the mobile phone device 10 has been exemplified, transmission of voice calls or electronic mails may also by applicable.

Furthermore, the communication terminal device may be, without being limited to the mobile phone device 10, a portable terminal unit such as a PDA comprising communication function, a digital camera, and a music player.

Various embodiments and changes may be made thereunto without departing from the broad spirit and scope of the invention. The above-described embodiments are intended to illustrate the present invention, not to limit the scope of the present invention. The scope of the present invention is shown by the attached claims rather than the embodiments. Various modifications made within the meaning of an equivalent of the claims of the invention and within the claims are to be regarded to be in the scope of the present invention.

This application is based on Japanese Patent Application No. 2008-001805 filed on Jan. 9, 2008 and including specification, claims, drawings and summary. The disclosure of the above Japanese Patent Application is incorporated herein by reference in its entirety.

What is claimed is:

1. A communication terminal device capable of communicating using any of a plurality of pieces of its own communication identifying information, the communication terminal device comprising:
an information storage unit which stores, when communication is performed using the communication identifying information, communication-related information indicating that the communication has been performed, in association with the communication identifying information;
a dividing unit which divides a display screen by the number of the plurality of pieces of communication identifying information; and
a display control unit which associates each of the divided screens divided by the dividing unit with each of the pieces of communication identifying information, and which displays the communication-related information for each of the pieces of communication identifying information on a corresponding divided screen.

2. The communication terminal device according to claim 1 further comprising:
a selecting unit which selects a divided screen arbitrarily from among the divided screens, under a condition where each of the divided screens which has been divided by the dividing unit is associated with each of the pieces of communication identifying information; and
a communication control unit which communicates using the communication identifying information corresponding to the divided screen selected by the selecting unit.

3. The communication terminal device according to claim 1, wherein the display control unit differentiates a background color of each divided screen.

4. The communication terminal device according to claim 1, being capable of communicating via voice call, wherein
the communication-related information stored in association with the communication identifying information is transmission and arrival information via voice call.

5. The communication terminal device according to claim 1, being capable of communicating via electronic mail, wherein
the communication-related information stored in association with the communication identifying information is transmission and arrival information via electronic mail.

6. The communication terminal device according to claim 1, wherein the display control unit also displays the number of times of communication performed using the communication identifying information when displaying the communication-related information stored in association with the communication identifying information.

7. The communication terminal device according to claim 1 wherein the display control unit also displays a communication time and date when the communication has been performed using the communication identifying information, when displaying the communication-related information stored in association with the communication identifying information.

8. The communication terminal device according to claim 1, wherein the display control unit displays a type of the communication when displaying the communication-related information stored in association with the communication identifying information.

9. A communication terminal device capable of communicating using any of a plurality of pieces of its own communication identifying information, the communication terminal device comprising:
an information storage unit which stores, when communication is performed using the communication identifying information, communication-related information indicating that the communication has been performed, in association with the communication identifying information; and
a display control unit which displays, when displaying the communication-related information for each of the pieces of communication identifying information, the communication-related information at a display position within a predefined screen assigned to each of the pieces of communication identifying information.

10. The communication terminal device according to claim 9, being capable of communicating via voice call, wherein
the communication-related information stored in association with the communication identifying information is transmission and arrival information via voice call.

11. The communication terminal device according to claim 9, being capable of communicating via electronic mail, wherein
the communication-related information stored in association with the communication identifying information is transmission and arrival information via electronic mail.

12. The communication terminal device according to claim 9, wherein the display control unit also displays a number of times of the communication performed using the communication identifying information when displaying the communication-related information stored in association with the communication identifying information.

13. The communication terminal device according to claim 9 wherein the display control unit also displays a communication time and date when the communication has been performed using the communication identifying information, when displaying the communication-related information stored in association with the communication identifying information.

14. The communication terminal device according to claim 9 wherein the display control unit displays a type of the communication when displaying the communication-related information stored in association with the communication identifying information.

15. A storage medium that stores a program causing a computer to realize the functions of:
storing, when communication is performed using any of a plurality of pieces of its own communication identifying information, communication-related information indicating that the communication has been performed, in association with the communication identifying information; and
dividing a display screen by the number of the plurality of pieces of communication identifying information; and
associating each of the divided screens with each of the pieces of communication identifying information, and displaying the communication-related information for each of the pieces of communication identifying information on a corresponding divided screen.

16. A storage medium that stores a program causing a computer to realize the functions of:
storing, when communication is performed using any of a plurality of pieces of its own communication identifying information, communication-related information indicating that the communication has been performed, in association with the communication identifying information; and
displaying, when displaying the communication-related information for each of the pieces of communication identifying information, the communication-related information at a display position within a predefined screen assigned to each of the pieces of communication identifying information.
